(19) United States
(12) Patent Application Publication
(10) Pub. No.: US 2005/0136278 A1
(43) Pub. Date: Jun. 23, 2005

(54) Method for making artificial pine heartwood

(76) Inventors: G. Frederick Hutter, Charleston, SC (US); David Lawrence Smith, Charleston, SC (US); Frederick Eugene Bishop JR., Charleston, SC (US)

Correspondence Address: MeadWestvaco Corporation, 3950 Faber Place Drive, Post Office Box 118005, Charleston, SC, 29423-8005, US

(21) Appl. No.: 10/993,440

(22) Filed: Nov. 22, 2004

Related U.S. Application Data
(63) Continuation-in-part of application No. 10/738,309, filed on Dec. 17, 2003, now abandoned.

(51) Int. Cl. B05D 1/18; B32B 21/08

(52) U.S. Cl. 428/537.1; 427/440

(57) ABSTRACT

This invention relates to the production of artificial pine heartwood. More particularly, the invention relates to a method for treating sapwood from trees of the family Pinaceae with rosin and/or a rosin derivative in order to give the treated sapwood physical and esthetic properties similar to that exhibited by yellow pine heartwood.

This is a continuation-in-part application of co-pending and commonly assigned U.S. application Ser. No. 10/738,309 filed on Dec. 17, 2003.

### FIELD OF INVENTION

This invention relates to the production of artificial pine heartwood. More particularly, the invention relates to a method for treating sapwood from trees of the family Pinaceae with rosin or a rosin derivative in order to give the treated sapwood physical and esthetic properties similar to that exhibited by yellow pine heartwood.

### BACKGROUND OF THE INVENTION

The term “southern yellow pine” is generally used in the art to refer to the wood from five closely related species of pine trees that are native to the American southeast: longleaf pine (Pinus palustris), shortleaf pine (P. echinata), loblolly pine (P. taeda), slash pine (P. elliottii) and pond pine (P. serotina). The heartwood of southern yellow pine species is highly desirable as a flooring material due to its density and hardness. Many people find the heartwoods' yellowish-to-reddish color and resinous surface appearance esthetically pleasing, which leads to its use in rustic furniture as well as flooring and other building materials. In addition to being harder, denser, and more esthetically attractive than pine sapwood, such heartwood also tends to be more resistant to warping and checking on aging and more resistant to insect damage.

Heartwood, as the name implies, comes from the inner part of the tree trunk. It is wood that is essentially dead, whose cells have begun to fill with resinous material. In pine heartwood, this resinous material is believed to consist primarily of rosin acids and oxidized and/or polymerized derivatives of rosin acids. It is the presence of this resinous material that provides the desirable physical and esthetic properties noted above.

Current forest management practices lead to most pine trees being harvested while they are relatively young, at a growth stage wherein the trees contain little or no heartwood. Therefore the commercial supply of pine heartwood is more or less limited to the few stands of old forest that can still be found and lumber recycled from the disassembly of old buildings and other structures. This leads to pine heartwood being several times more expensive than readily available pine sapwood. It would, therefore, be economically advantageous to have an efficient and inexpensive process for treating pine sapwood to produce sapwood having physical and esthetic properties similar to those exhibited by pine heartwood.

Therefore, it is an object of the present invention to provide a method for treating pine sapwood to produce sapwood having physical and esthetic properties similar to those exhibited by pine heartwood.

A further object of the present invention is to provide a method for producing simulated pine heartwood.

Other objects and advantages of the present invention will become apparent from the following detailed description.

### SUMMARY OF THE INVENTION

The objects of this invention are met by a process that impregnates pine sapwood with either a liquid dispersion or a liquid solution which contains rosin and/or a rosin derivative, thereby filling the pores of the sapwood with a resinous material which mimics that present in pine heartwood. The simulated pine heartwood produced by this process exhibits physical and esthetic properties similar to those possessed by naturally occurring pine heartwood.

### DESCRIPTION OF THE PREFERRED EMBODIMENT

A process for producing simulated pine heartwood of the present invention comprising the step of impregnating at least one sapwood wood part from a tree of the Pinaceae family by immersing the wood part at ambient temperature in either a liquid dispersion or a liquid solution, wherein the non-volatile content of the liquid dispersion or liquid solution comprises:
(a) from about 25% to 100% by weight of at least one member selected from the group consisting of rosins, rosin derivatives, and combinations thereof, and
(b) up to about 75% by weight at least one additive resinous material selected from the group consisting of fatty acids, dimer acids, triglycerides, alkyd resins, terpenes, phenolic resins, hydrocarbon resins, phenolic-modified terpene resins, phenolic-modified hydrocarbon resins, tall oil pitch, and combinations thereof,
   for a time sufficient to produce a simulated pine heartwood wood part having a density of at least 0.7 g/cc when dried to a moisture content of about 12%.

Sapwood which is suitable for use in the present invention may be obtained from any tree of the Pinaceae family including the following generae: Abies, Cathaya, Cedrus, Keteleeria, Larix, Nothotsuga, Picea, Pinus, Pseudolarix, Pseudotsuga, and Tsuga. It is preferred to use sapwood from a member selected from the group consisting of Pinus palustris, P. echinata, P. taeda, P. elliottii, P. serotina, and hybrids thereof.

In the context of the present invention the term “wood part” relates to any wooden article, such as flooring strips, furniture parts, boards, beams, panels, veneers, frames, and construction elements.

Rosins that are suitable for use in the present invention include tall oil rosin, gum rosin, wood rosin, and combinations thereof. Rosin derivatives that are suitable for use in the process of the invention include, but are not limited to, the following: hydrogenated rosins, disproportionated rosins, formaldehyde-treated rosins, dimerized rosins, polymerized rosin, fumarated rosins, maleated rosins, styrenated rosins, phenolic-modified rosins, acrylic-modified rosins, hydrocarbon-modified rosins, rosin-vinylic copolymers, rosin salts, hydrogenated rosin salts, disproportionated rosin salts, formaldehyde-treated rosin salts, dimerized rosin salts, polymerized rosin salts, fumarated rosin salts, maleated rosin salts, styrenated rosin salts, phenolic-modified rosin salts, acrylic-modified rosin salts, hydrocarbon-modified rosin salts, rosin-vinylic copolymer salts, rosin esters, hydrogenated rosin esters, disproportionated rosin esters, formaldehyde-treated rosin esters, dimerized rosin esters, polymerized rosin esters, fumarated rosin esters, maleated rosin esters, styrenated rosin esters, phenolic-modified rosin esters, acrylic-modified rosin esters, hydrocarbon-modified rosin esters, rosin-vinylic copolymer esters, rosin amides, hydrogenated rosin amides, disproportionated rosin amides, formaldehyde-treated rosin amides, dimerized rosin amides, polymerized rosin amides, fumarated rosin amides, maleated rosin amides, styrenated rosin amides, phenolic-modified rosin amides, acrylic-modified rosin amides, hydrocarbon-modified rosin amides, rosin-vinylic copolymer amides, and combinations thereof. Many such rosin derivatives are commercially available, being used in the manufacture of inks, adhesives, paper sizes, and the like. The manufacture of these rosins and rosin derivatives are know to those skilled in the art, and is described in the Kirk-Othmer Encyclopedia of Chemical Technology, 4^{th} edition, vol. 21, pp. 292-297, and in the book “Naval Stores,” D. F. Zinkel and J. Russell, eds., Pulp Chemicals Association, New York, 1989, passim, especially pp. 683-694, both of which works are incorporated herein by reference. Rosin-vinylic copolymers which are suitable for use in the invention include those taught in U.S. Pat. No. 6,437,033, which is herein incorporated by reference. Suitable rosin amides include those taught in U.S. Pat. Nos. 5,066,331 and 5,152,832, which are incorporated herein by reference.

Where desired, one or more additive resinous materials can be admixed with the rosins and/or rosin derivatives—as long as the rosins and/or rosin derivatives comprise at least about 25% by weight of the non-volatile content of the immersing liquid dispersion or liquid solution. Additive resinous materials most suitable for admixture with the rosins and rosin derivatives are those with solubility parameters similar to those of rosin acids. Examples include, but are not limited to, the following: fatty acids, dimer acids, triglycerides, alkyd resins, terpenes, phenolic resins, hydrocarbon resins, phenolic-modified terpene resins, phenolic-modified hydrocarbon resins, tall oil pitch, and combinations thereof. Particularly useful in the process of the invention are mixtures of rosin and fatty acids obtained by the distillation of tall oil.

Liquid dispersions and liquid solutions have, by definition, both non-volatile and volatile content. In the present process, a skilled artisan will select the amount of non-volatile content contained in the liquid dispersion or liquid solution so as to yield the desired degree of density in the final treated wood part. Typically, the non-volatile content is in the range of about 20% to about 60% by total weight of the liquid dispersion or liquid solution.

Dispersions of rosin and/or rosin derivatives (and, where desired, additive resinous materials) which are suitable for use in the present invention are liquid at ambient temperature and may be impregnated into the sapwood wood parts in that form. In the context of the present invention, the term “ambient temperature” is typically a temperature in the range of about −25° C. to about 40° C.

Alternatively, the rosin and/or rosin derivative (and, where desired, additive resinous materials) can be dissolved in a suitable organic solvent and impregnated into the sapwood wood parts in a liquid solution form at ambient temperature. Rosins, most rosin derivatives, and most of the additive resinous materials are soluble in relatively inexpensive aliphatic or aromatic hydrocarbon solvents such as mineral spirits, toluene, or xylene. However, where desired more polar solvents (such as esters, alcohols, ketones, and the like) may also be used. The solvents used should be sufficiently volatile so that they evaporate readily from the treated wood. The lower viscosity and dynamic surface tension of the liquid solutions relative to the liquid dispersions allow for more rapid penetration of the immersed sapwood wood parts.

Rosins, high acid number rosin derivatives (such as hydrogenated rosins, disproportionated rosins, dimerized rosins, maleated rosins, fumarated rosins, and partial esters of maleated or fumarated rosins with various polyols known in the art as soluble maleic resins), and some of the additive resinous materials (such as fatty acids, dimer acids, water-reducible alkyd resins, and the like) are soluble in water in the presence of aqueous bases such as alkali metal hydroxides or carbonates, ammonia, low molecular weight alkylamines or alkanolamines, and the like. These materials can therefore be impregnated into the immersed sapwood as aqueous liquid solutions. Alkylamines containing from one to about six carbon atoms are suitable for use in solubilizing the rosins and/or rosin derivatives of the present invention. Examples include, but are not limited to, the following: methylamine, dimethylamine, trimethylamine, triethylamine, morpholine, N-methylmorpholine, and combinations thereof. Suitable alkanolamines are those containing from two to about nine carbon atoms. Examples include, but are not limited to, the following: ethanolamine, diethanolamine, triethanolamine, isopropanolamine, diisopropanolamine, triisopropanolamine, N-methylethanolamine, dimethylethanolamine, diethylethanolamine, N,N-dimethylneopentanolamine, 1-amino-3-propanol, 2-amino-2-methyl-1,3-propanediol, and combinations thereof. Likewise, certain transition metal salts of most of the rosins and rosin derivatives of the present invention (such as the salts of zinc, copper, or zirconium) are also soluble in the presence of aqueous ammonia, amines, or alkanolamines and can, therefore, also be impregnated into the sapwood wood parts as aqueous liquid solutions. It is well within the ability of one skilled in the art to produce liquid solutions which contain the rosins, rosin derivatives, and additive resinous materials taught herein.

The preferred method for impregnating the rosins and/or rosin derivatives into the sapwood wood parts is to use an aqueous liquid dispersion or an aqueous emulsion of the rosins and/or rosin derivatives. The use of an aqueous liquid dispersion or an aqueous emulsion avoids the use of a volatile organic solvent or solubilizing amine that may present environmental issues. The preparation of emulsions is discussed in the Kirk-Othmer Encyclopedia of Chemical Technology, 4^{th} edition, vol. 9, pp. 393-412 and references therein, which are incorporated herein by reference. Also useful in producing fine particle size aqueous dispersions of rosins or rosin derivatives is the miniemulsion technique taught in U.S. Pat. No. 4,177,177, which is incorporated herein by reference. Rosins, rosin derivatives, and additive resinous materials mixed with the rosins and/or rosin derivative can be readily dispersed in water using conventional surfactants and high-shear mixing. These surfactants may be nonionic, cationic, anionic, or mixtures of nonionic with either anionic or cationic.

It is preferred that the liquid dispersions of the present invention have an average particle size of less than 500 nanometers (more preferably less than about 400 nm) to allow for easy penetration through the pores of the sapwood wood parts.

The impregnation of the sapwood wood parts with the liquid dispersion or liquid solution that contains the rosins and/or rosin derivatives (and, where desired, the additive resinous materials) can be carried out at atmospheric pressure, but it is more advantageously carried out at elevated pressure. “Loading” is a synonym for the absorption of the impregnating composition by the sapwood wood parts and is—in the context of the present invention—also used for the respective technical impregnating process of immersing, preferably, applying pressure and subsequent relieving of the pressure. Methods of treating wood with chromated copper arsenate solutions at elevated pressures are well known in the art. The same equipment (e.g., pressure vessels) used in such pesticide treatment methods can be readily adapted to the treatment of sapwood wood parts with the liquid solutions or the liquid dispersions of the present invention. Indeed, the sapwood wood parts may be immersed in any suitable vessel which can be closed to generate the given excess pressure for the loading. Likewise, pressures which are typically used for the production of chromated copper arsenate treated wood are suitable for use in the present process. A preferred pressure range is from about 50 psi to about 200 psi.

Southern yellow pine sapwood when dried to a moisture content of about 12% typically has a density of about 0.55 to 0.60 grams/cubic centimeter. In contrast, southern yellow pine heartwood under similar conditions typically has a density of about 0.75 to 0.85 g/cc. In order to produce simulated pine heartwood that has the same feel and appearance as natural heartwood, in the present invention the sapwood wood part is immersed at ambient temperature in either the liquid dispersion or the liquid solution for a time sufficient to produce a simulated pine heartwood wood part having a density of at least 0.7 g/cc (preferably in the range of about 0.75 to about 0.85 g/cc) when dried to a moisture content of about 12%. A person skilled in the art will choose an impregnating liquid dispersion or liquid solution such that the sapwood wood part to be impregnated reaches the desired degree of density within an appropriate time depending on its porosity—optionally with the use of vacuum and/or pressure.

In addition to density, hardness is an important consideration in many applications for pine heartwood, such as flooring. Hardness of wood is generally measured by the Janka Ball test. This test is described in ASTM Standard D 143-94, Section 13, which is incorporated herein by reference. For heartwood type flooring, a Janka Ball hardness value of at least 1000 pounds, preferably 1200 pounds, or greater, is desirable. Untreated yellow pine sapwood generally has a Janka Ball hardness value in the range of 400-700 pounds. The rosin-based treatment described herein can substantially increase the hardness of the sapwood, thus making it more suitable for flooring use.

A preferred embodiment of the present invention comprises the steps of:
(i) immersing at ambient temperature at least one sapwood wood part from a tree of the Pinaceae family in either a liquid dispersion or a liquid solution, wherein the non-volatile content of the liquid dispersion or liquid solution comprises:
   (a) from about 25% to 100% by weight of at least one member selected from the group consisting of rosins, rosin derivatives, and combinations thereof, and
   (b) up to about 75% by weight at least one additive resinous material selected from the group consisting of fatty acids, dimer acids, triglycerides, alkyd resins, terpenes, phenolic resins, hydrocarbon resins, phenolic-modified terpene resins, phenolic-modified hydrocarbon resins, tall oil pitch, and combinations thereof;
(ii) loading the immersed sapwood wood part with said liquid dispersion or liquid solution under excess pressure for a time sufficient to produce a simulated pine heartwood wood part having a density of at least 0.7 g/cc when dried to a moisture content of about 12%, thereafter relieving the excess pressure; and
(iii) removing the simulated pine heartwood wood part from the liquid dispersion or liquid solution.

The upper limit of the applicable pressure in step (ii) mainly depends on the respective crushing strength of the wood part, as collapsing of the wood should be avoided. It is preferred to apply a pressure in the range of about 50 psi to about 200 psi. Where desired, a vacuum may be applied during step (i) to support the efficiency of the loading.

In addition to being denser than the sapwood, yellow pine heartwood is somewhat redder in color. This effect tends to be more pronounced in very old wood, which is often referred to in the art as “red heart.” Red heart tends to be the most commercially desirable type of pine heartwood for high-end applications (such as antique furniture reproduction manufacturing and the like). As rosin and most of its derivatives tend to darken on oxidation, the darker color of the heartwood can be mimicked in the treated sapwood by blowing air or oxygen through the rosin and/or rosin derivative used before employing it in the treatment process.

Where desired, at least one dye and/or pigment can be added to the liquid dispersions and liquid solutions of the present invention in order to impart a reddish or brownish color to the resulting simulated pine heartwood. Pigments are generally preferred due to their greater light fastness. Highly stable pigments such as yellow, red, or brown iron oxides are especially preferred so that the color is not lost on prolonged exposure to light (as when flooring is exposed to direct sunlight through a window, for example).

The following examples are provided to further illustrate the present invention and are not to be construed as limiting the invention in any manner.

### EXAMPLE 1

A toluene solution of a metal salt of maleated rosin was made by heating and stirring together 1,000 grams of tall oil rosin and 40 grams of maleic anhydride at 185° C. for one hour. The resulting maleated rosin was then dissolved in 600 grams of toluene. Thereafter 125 grams of zinc oxide and 2 grams of lime were added, and the mixture was refluxed while stirring in a flask fitted with a Dean-Stark trap to remove the water of reaction. The resulting zinc resinate solution had a solids content of 67.4% and a viscosity of 310 cP.

A piece of 3.25 inch yellow pine sapwood strip flooring was placed in a cylindrical pressure vessel and subjected to a vacuum for twenty minutes. Then a liquid solution obtained by diluting the above zinc resinate solution to 57.5% solids with toluene was introduced into the vessel at ambient temperature, immersing the wood. The vessel was pressurized to 150 psi for thirty minutes. Thereafter the pressure was released, the wood was removed from the pressure vessel, and the toluene in the wood was allowed to evaporate. The resulting piece of simulated pine heartwood, when dried to a moisture content of about 12%, had a density of 0.788 g/cc. (In contrast, the sapwood prior to treatment had an initial density of 0.59 g/cc at a moisture content of about 12%.) The piece of simulated pine heartwood had the feel and resinous appearance of yellow pine heartwood.

### EXAMPLE 2

A piece of 3.25 inch yellow pine sapwood strip flooring was placed in a cylindrical pressure vessel and subjected to a vacuum for twenty minutes. Then an aqueous liquid solution comprising a 33.2% solids solution of HYATOP H-2720 (a rosin-vinylic copolymer resin commercially available from MeadWestvaco Corp.) in aqueous ammonia was introduced into the vessel at ambient temperature, immersing the wood. The vessel was pressurized to 150 psi for thirty minutes. Thereafter the pressure was released, the wood was removed from the pressure vessel, and the water and ammonia in the wood was allowed to evaporate. The resulting piece of simulated pine heartwood, when dried to a moisture content of about 12%, had a density of 0.789 g/cc. (In contrast, the sapwood prior to treatment had an initial density of 0.59 g/cc at a moisture content of about 12%.) The piece of simulated pine heartwood had the feel and resinous appearance of yellow pine heartwood.

### EXAMPLE 3

A rosin containing aqueous emulsion was prepared by mixing 356 grams of RESIN 95 (a disproportionated rosin commercially available from MeadWestvaco Corp.), 444 grams of M28B (a distilled tall oil product comprising about 28 weight-% rosin and about 72 weight-% fatty acid commercially available from MeadWestvaco Corp.), 1,168 grams of deionized water, and 32 grams of sodium lauryl sulfate and subjecting the mixture to high speed stirring. The resulting aqueous emulsion (“Emulsion A”) had a viscosity of 12 cP.

A piece of 3.25 inch yellow pine sapwood strip flooring was placed in a cylindrical pressure vessel and subjected to a vacuum for twenty minutes. Then Emulsion A was introduced into the vessel at ambient temperature, immersing the wood. The vessel was pressurized to 150 psi for thirty minutes. Thereafter the pressure was released, the wood was removed from the pressure vessel, and the water in the wood was allowed to evaporate. The resulting piece of simulated pine heartwood, when dried to a moisture content of about 12%, had a density of 0.84 g/cc. (In contrast, the sapwood prior to treatment had an initial density of 0.59 g/cc at a moisture content of about 12%.) The piece of simulated pine heartwood had the feel and resinous appearance of yellow pine heartwood.

### EXAMPLE 4

An iron oxide pigment dispersion was prepared by mixing 17 grams of a red iron oxide pigment commercially available from Elementis Corp., 51.6 grams of a 27.1% solids solution of TRUDOT IJ-4655 (an acrylic polymer pigment dispersant commercially available from MeadWestvaco Corp.) in aqueous ammonia, 1.0 gram of concentrated ammonium hydroxide, 0.5 gram of SURFYNOL DF-75 (a surfactant commercially available from Air Products Corp.), 29.9 grams of deionized water, and 120.0 grams of glass beads in a steel beaker. The mixture was subjected to high speed stirring, and then the glass beads were removed by filtration to give a 22% solids pigment dispersion (“Pigment A”).

A piece of 3.25 inch yellow pine sapwood strip flooring was placed in a cylindrical pressure vessel and subjected to a vacuum for twenty minutes. Six grams of Pigment A were mixed with 1150 grams of Emulsion A, and the resulting mixture was introduced into the vessel at ambient temperature, immersing the wood. The vessel was pressurized to 150 psi for thirty minutes. Thereafter the pressure was released, the wood was removed from the pressure vessel, and the water in the wood was allowed to evaporate. The resulting piece of simulated pine heartwood, when dried to a moisture content of about 12%, had a density of 0.79 g/cc. (In contrast, the sapwood prior to treatment had an initial density of 0.59 g/cc at a moisture content of about 12%.) The piece of simulated pine heartwood had the appearance of red heart pine wood.

Many modifications and variations of the present invention will be apparent to one of ordinary skill in the art in light of the above teachings. It is therefore understood that the scope of the invention is not to be limited by the foregoing description, but rather is to be defined by the claims appended hereto.

1. A process for producing simulated pine heartwood, comprising the step of impregnating at least one sapwood wood part from a tree of the Pinaceae family by immersing the wood part at ambient temperature in either a liquid dispersion or a liquid solution, wherein the non-volatile content of the liquid dispersion or the liquid solution comprises:
(a) from about 25% to 100% by weight of at least one member selected from the group consisting of rosins, rosin derivatives, and combinations thereof, and
(b) up to about 75% by weight at least one additive resinous material selected from the group consisting of fatty acids, dimer acids, triglycerides, alkyd resins, terpenes, phenolic resins, hydrocarbon resins, phenolic-modified terpene resins, phenolic-modified hydrocarbon resins, tall oil pitch, and combinations thereof,
for a time sufficient to produce a simulated pine heartwood wood part having a density of at least 0.7 g/cc when dried to a moisture content of about 12%.

2. The process of claim 1, wherein the sapwood wood part is a member selected from the group consisting of flooring strips, furniture parts, boards, beams, panels, veneers, frames, construction elements, plywood panels, and laminates.

3. The process of claim 1 wherein the sapwood wood part is from a member selected from the group consisting of Pinus palustris, Pinus echinata, Pinus taeda, Pinus elliottii, Pinus serotina, and hybrids thereof.

4. The process of claim 1 wherein the rosin is a member selected from the group consisting of tall oil rosin, gum rosin, wood rosin, and combinations thereof.

5. The process as in claim 1 wherein the rosin derivative is a member selected from the group consisting of hydrogenated rosins, disproportionated rosins, formaldehyde-treated rosins, dimerized rosins, polymerized rosin, fumarated rosins, maleated rosins, styrenated rosins, phenolic-modified rosins, acrylic-modified rosins, hydrocarbon-modified rosins, rosin-vinylic copolymers, rosin salts, hydrogenated rosin salts, disproportionated rosin salts, formaldehyde-treated rosin salts, dimerized rosin salts, polymerized rosin salts, fumarated rosin salts, maleated rosin salts, styrenated rosin salts, phenolic-modified rosin salts, acrylic-modified rosin salts, hydrocarbon-modified rosin salts, rosin-vinylic copolymer salts, rosin esters, hydrogenated rosin esters, disproportionated rosin esters, formaldehyde-treated rosin esters, dimerized rosin esters, polymerized rosin esters, fumarated rosin esters, maleated rosin esters, styrenated rosin esters, phenolic-modified rosin esters, acrylic-modified rosin esters, hydrocarbon-modified rosin esters, rosin-vinylic copolymer esters, rosin amides, hydrogenated rosin amides, disproportionated rosin amides, formaldehyde-treated rosin amides, dimerized rosin amides, polymerized rosin amides, fumarated rosin amides, maleated rosin amides, styrenated rosin amides, phenolic-modified rosin amides, acrylic-modified rosin amides, hydrocarbon-modified rosin amides, rosin-vinylic copolymer amides, and combinations thereof.

6. The process of claim 1 wherein the liquid dispersion is an aqueous emulsion.

7. The process of claim 6 wherein the aqueous emulsion further comprises at least one surfactant.

8. The process of claim 1 wherein the liquid dispersion has an average particle size of less than 500 nm.

9. The process of claim 1 wherein the liquid dispersion further comprises at least one member selected from the group consisting of dyes, pigments, and combinations thereof.

10. The process of claim 1 wherein the liquid solution further comprises at least one organic solvent.

11. The process of claim 1 wherein the liquid solution further comprises at least one aqueous base.

12. The process of claim 1 wherein the liquid solution further comprises at least one member selected from the group consisting of dyes, pigments, and combinations thereof.

13. The process of claim 1 wherein the simulated pine heartwood wood part has a density in the range of about 0.75 g/cc to about 0.85 g/cc when dried to a moisture content of about 12%.

14. The process of claim 1 wherein the simulated pine heartwood wood part has a Janka Ball hardness of at least 1000.

15. The simulated pine heartwood wood part of claim 1.

16. A process for producing simulated pine heartwood, comprising the steps of:
(i) immersing at ambient temperature at least one sapwood wood part from a tree of the Pinaceae family in either a liquid dispersion or a liquid solution, wherein the non-volatile content of said liquid dispersion or liquid solution comprises:
(a) from about 25% to 100% by weight of at least one member selected from the group consisting of rosins, rosin derivatives, and combinations thereof, and
(b) up to about 75% by weight at least one additive resinous material selected from the group consisting of fatty acids, dimer acids, triglycerides, alkyd resins, terpenes, phenolic resins, hydrocarbon resins, phenolic-modified terpene resins, phenolic-modified hydrocarbon resins, tall oil pitch, and combinations thereof,
(ii) loading the immersed sapwood wood part with said liquid dispersion or liquid solution under excess pressure for a time sufficient to produce a simulated pine heartwood wood part having a density of at least 0.7 g/cc when dried to a moisture content of about 12%, thereafter relieving the excess pressure; and
(iii) removing the simulated pine heartwood wood part from the liquid dispersion or liquid solution.

17. The process of claim 16, wherein the sapwood wood part is a member selected from the group consisting of flooring strips, furniture parts, boards, beams, panels, veneers, frames, construction elements, plywood panels, and laminates.

18. The process of claim 16 wherein a vacuum is applied during step (i).

19. The process of claim 16 wherein a pressure in the range of about 50 psi to about 200 psi is applied in step (ii).

20. The simulated pine heartwood wood part of claim 16.

21. The simulated pine heartwood wood part of claim 20 characterized by a Janka Ball hardness value of at least 1000 pounds.

22. The simulated pine heartwood wood part of claim 21 characterized by a Janka Ball hardness value of at least 1200 pounds.
